(19) United States
(12) Patent Application Publication
(10) Pub. No.: US 2019/0134649 A1
(43) Pub. Date: May 9, 2019

(54) Low-Profile, High-Pressure Dust Separator and Collector

(71) Applicants: Robert M. Witter, Englewood, FL (US); Jeffrey M. Hill, Cicero, NY (US); John J. Fitzsimmons, Clay, NY (US)

(72) Inventors: Robert M. Witter, Englewood, FL (US); Jeffrey M. Hill, Cicero, NY (US); John J. Fitzsimmons, Clay, NY (US)

(73) Assignee: Oneida Air Systems, Inc., Syracuse, NY (US)

(21) Appl. No.: 16/027,931

(22) Filed: Jul. 5, 2018

Related U.S. Application Data
(60) Provisional application No. 62/528,784, filed on Jul. 5, 2017.

(51) Int. Cl. B04C 5/081; B04C 5/04; B04C 5/185; B04C 5/15; B04C 9/00; B01D 50/00; B01D 45/16; B01D 46/24; B01D 46/00

(52) U.S. Cl. CPC B04C 5/081; B04C 5/04; B04C 5/185; B04C 5/15; B04C 2009/004; B01D 50/002; B01D 45/16; B01D 46/2403; B01D 46/0068; B04C 9/00

(57) ABSTRACT

A compact dust separator and collector employs a generally cylindrical separator section having a inlet tube where air and entrained dust particles enters the separator section, a top plate with a vortex tube extending downward, and a separator baffle plate disposed at a lower end of said separator section below a lower end of the vortex tube. The baffle plate has peripheral geometry that defines a peripheral gap from the cylindrical separator section wall, with the gap increasing in width in the direction of air flow. There is a blower and filter section above the separator section and a collection section below. The vortex tube can have a cylindrical mesh extending down to the baffle plate, which may have a self-emptying dust cup.

This application claims priority under 35 U.S.C. 119(e) of Provisional Application Ser. No. 62/528,784, Jul. 5, 2017, the disclosure of which is incorporated by reference herein.

### BACKGROUND OF THE INVENTION

Dust collection systems often rely on a cyclonic separator that consists of a conical section with a tangential inlet tube and a central vortex tube and a bottom opening. The dust-laden air enters through the tangential inlet tube and the dust is separated through a combination of centrifugal force and aerodynamic forces where about 99% of the dust drops down the bottom opening or nose, and then into a collection bin while the stream of working air exits through the center vortex tube to a blower and final filter or directly to the ambient space or outdoors. Separation of dust from the air stream minimizes the material entering and lodging in the filters. Cyclone-based separation is a well-established and reliable system; however to maximize effectiveness the conical section needs to be quite tall in relation to its diameter, which can be a disadvantage in a smaller system. Many smaller woodshops and other work areas are limited in space availability, especially vertically, and so it is often difficult to find space for a standard, cyclonic dust separator.

A system that simply omits a cyclonic separator quickly over-loads the filter, which causes a drop in air flow and static pressure, resulting in lowered performance and requires the frequent removal of the filters for cleaning or replacement.

### SUMMARY OF THE INVENTION

The solution to this need, especially for the smaller shops, is to employ a low-profile separator section which may require ¼ or less of the height of a conventional conical cyclone. With such a design, the overall dimensions make possible a system much more compact than a conventional cyclone system. The combination of the high flow, high operating pressure and compact size is unique and offers the performance of a larger system in a more portable form. A typical size for a smaller wood shop can be 24 inches wide by 24 inches deep and 54 inches high. In addition, the low-profile high-pressure system provides self-cleaning of filters and modular options to extend the product's versatility.

The separator chamber of the unit has a separator plate at its lower end with a peripheral slot or gap that extends e.g., about 230 degrees around its perimeter and which increases in gap width in the direction of air flow from perhaps a quarter inch to a round opening of perhaps two inches, and employs edge geometry that helps prevent dust that is captured in eddy currents in the collection bin from re-entering the separation chamber. The dust separated in the separation chamber or separation section drops through this circumferential gap into the collection bin below.

The low-profile high-pressure system is ideal for small diameter ductwork, small wood-working tools with small ports (for example 2-inch ports), and on equipment for wood floor sanding and concrete floor grinding.

The low-profile, high-pressure system can favorably include a separator section, a collection bin section, a filter section and a motor-blower section. The unit can be constructed from metal or plastic or a combination of the two, or of composite material. Plastics used for this purpose may be generally static conductive or static dissipative high density polyethylene.

The unit can powered electrically, with a three-motor version using typically 230 volts, 17 amps, single phase; and a single motor version using 115 volts, 13.5 amps single phase.

The low-profile separator primarily functions by centrifugal force projecting the solid dust particles outward while the air stream flows inwards towards the vortex tube outlet. The general arrangement has similarities to a “Thien baffle”. The low-profile, high-pressure arrangement of the present invention differs in the details which improve its performance i.e., lower pressure drop, better trash (large chunk) handling, better separation, more power and wider versatility.

In keeping with the main principles of this invention, there is provided a powerful compact, high pressure, high flow vacuum or dust collector utilizing a low profile separator section with a inlet to diameter ratio, favorably in the range of 3:1 to 4:1 and favorably with inlet diameter to height between the top of the inlet tube to top baffle of approximately 2.2:1. A separator baffle may have a contoured upper surface that encourages the outward flow of particles and is easily removed for clearing of trash from the separator section. The baffle plate has geometry to discourage re-uptake of material from the collection bin. This can include a toroid shaped section at the base of separator that segregates the dust loaded eddy flow in the collection bin from the exit zone of the baffle. The unit may have interchangeable baffles to accommodate different conditions or materials.

The compact, high-pressure, high flow dust collector if this invention stores the back washed dust that results from the pulse cleaning action and automatically dumps that material into the collection bin. The unit may feature secondary separation in the filter section by means of a toroid shaped compartment.

A vortex tube with a mesh element at its lower open end improves air flow and prevents filter blocking in the event of overfilling the collection bin.

The dust collector may be made in modular form so as to accommodate a variety of accessories, such as a wall mount bracket, various cart options, a hopper section, etc., and may have a small diameter inlet suitable for connecting to small portable tools.

The dust collector may have one or multiple motors, and one or multiple high-efficiency final filters, and may be portable, stationary or wall mounted. The dust collector separator section separates 99% of the incoming dust before filtration, and has a pulsing feature for reverse pulse cleaning of filters. The dust collector may employ a magnetic starter and remote control or other control mechanisms.

### BRIEF DESCRIPTION OF THE DRAWING

FIG. 1 is an elevation, partly cut-away, of a low-profile, high-pressure dust separator and collector unit according to one preferred embodiment of the invention.

FIG. 1A is an enlargement of a portion thereof.

FIG. 2 is a schematic partial elevation view taken at about 90 degrees from the aspect of FIG. 1

FIGS. 3A and 3B are bottom and top plan views, respectively, of the separator plate of this embodiment.

FIG. 4 is an illustrative top plan view for explaining the blowers and pulse plates as employed in this embodiment.

FIG. 5 is a schematic elevational cutaway view of an alternative embodiment of the present invention.

### DETAILED DESCRIPTION OF THE PREFERRED EMBODIMENT(S)

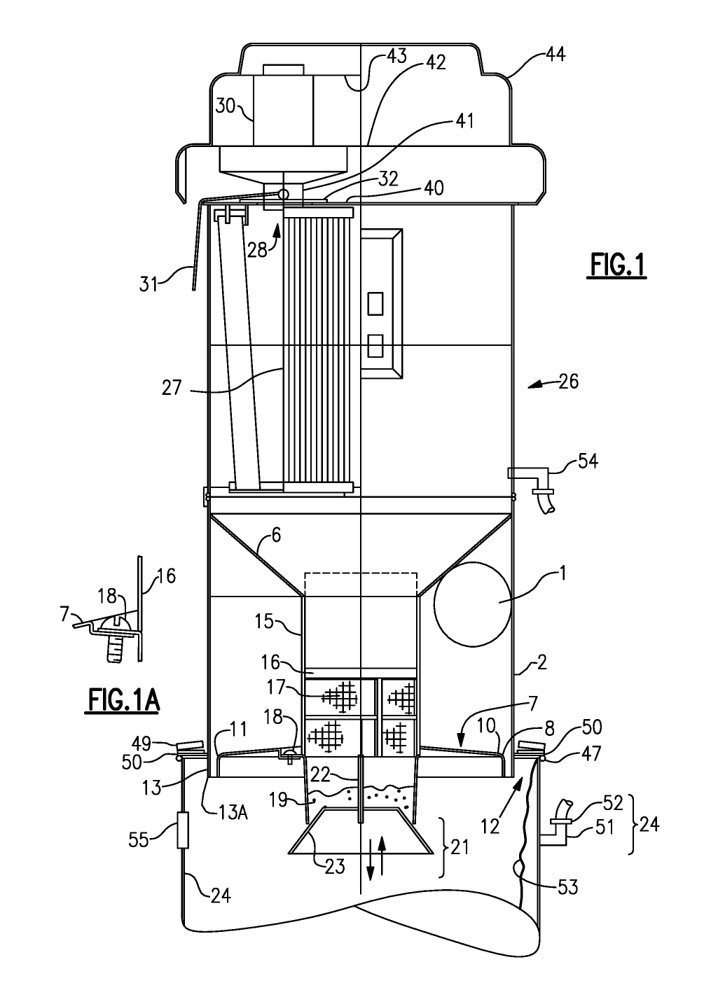

FIG. 1 shows an example of the LPHP separator partly cutaway. The low-profile separator section 2 is comprised of a tangential inlet tube 1, typically two-and-one-half to four inches in diameter; a cylindrical or tapered conical section 6 that is roughly three-and-one-half to four times the diameter of the inlet tube and 2.25 times the inlet diameter in height. The separator section 2 is disposed above a collection bin 24 and below a filter section 26 just above it.

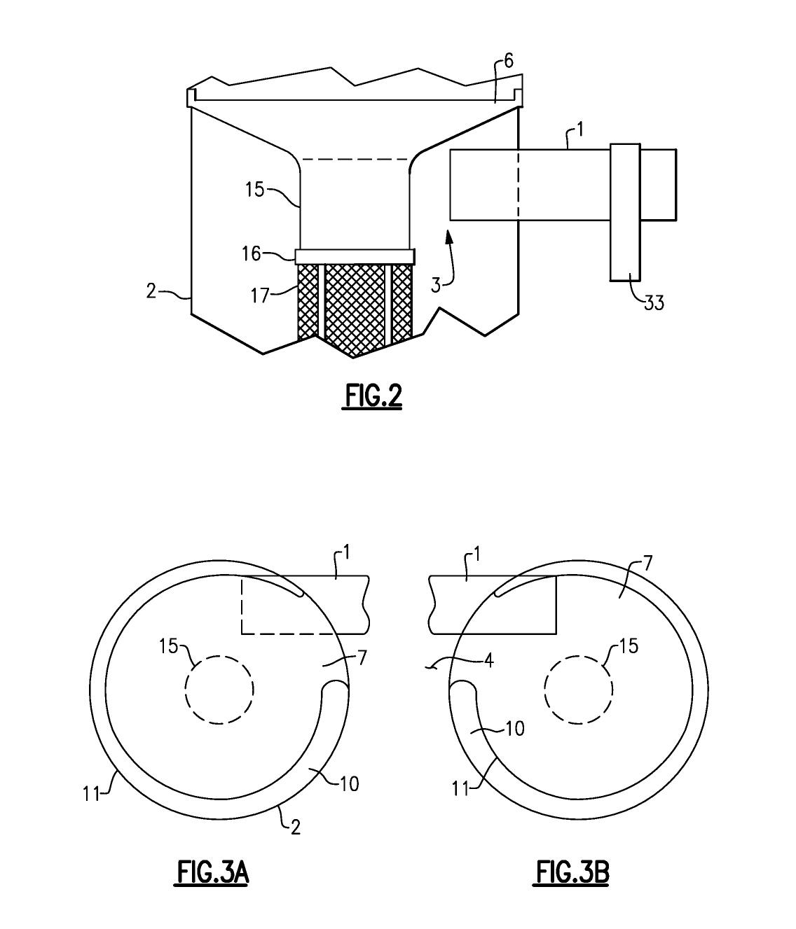

The inlet tube 1 extends more-or-less tangentially into the cylindrical separator section 2 to a radial line 3 (see FIG. 2), which creates a neutral vane. A neutral vane can alternatively be created with a ramp or a vane type structure. An inlet shutoff valve 33 may be included on the inlet tube 1, as part of the pulse cleaning system described later. The top of the inlet tube 1 may be even with the top 6 of the separator section, or in the case of a conical separator plate 6 as shown, it is located at the highest point possible within the interior space created by the conical separator plate.

The top plate 6 of the separator section 2 can be flat or conical forming a funnel to allow the flow of material downward from the filter section above it. Alternately a separator plate can be employed, as a flat member which can incorporate a collar formed by either an extended vortex tube 15 or a separate tray. This acts as a secondary separator where the dust-laden air enters into the filter chamber, expands and de-accelerates and can drop some of the dust before it reaches the filter, this section also acts as a catchment storage area for back-washed dust from pulse cleaning the filters, as described further on.

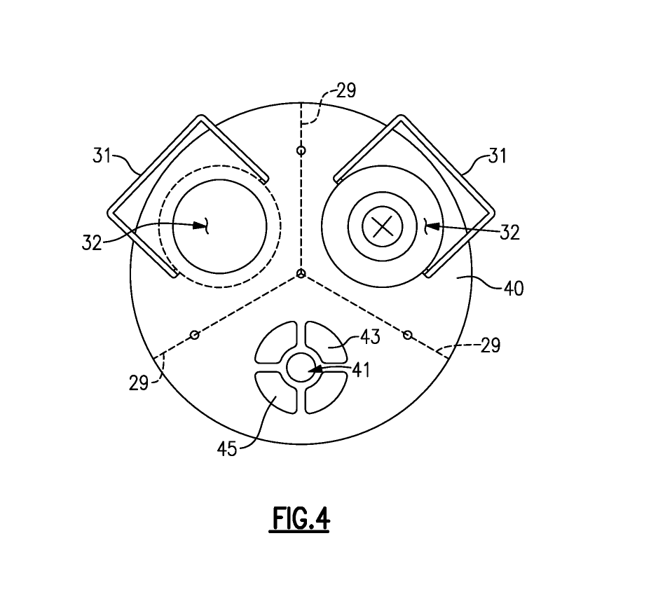

At the bottom of the separator section 2 is a baffle plate 7, shown also in the top and bottom views of FIGS. 3A and 3B. Its purpose is to provide a one-way passage for the dust and trash that has been centrifugally separated in the separator section 2. This baffle plate 7 can be a flat disc or a shallow cone, with or without a lip around its underside edge. For general use, the baffle plate 7 has a periphery 11 that spirals inward in the direction of air flow. As shown in FIGS. 3A and 3B, this creates a generally arcuate gap 10 that gradually increases along the perimeter of the baffle plate 7, for instance from ¼ inch to ¾ inches, with the gap widening to an enlarged opening at the end thereof, typically 2 inches in diameter. This arrangement allows the minimum area opening for the gap 10, while allowing chunks and trash to find their way to the collection bin without jamming in the opening of gap 10. For instance, the dimensions stated would allow a 2-inch diameter ball to drop though to the collection bin; also a tapered item like a wire nut would slide along until it reached a part of the gap 10 wide enough for it to drop through. A gap of consistent width would permit a wedge-shaped object to jam. The enlarged area is typically located about 230 degrees from the radial line of the inlet opening.

The baffle plate 7 is easily removable to allow the removal of trash that may be too large to pass through the gap or otherwise does not pass into bin. Also, the baffle plate can be changed from the standard configuration to a specialized configuration that may, for example, be optimized for fine dust but perhaps unable to handle trash or chunks.

During use, the collection bin 24 can experience eddy currents that are propelled by the incoming air; these eddy currents can carry dust back up into the area of the baffle and into the separator. This re-uptake reduces the unit's separation efficiency. To reduce the re-uptake two mechanisms are employed:

A. The first mechanism for reducing the re-uptake of dust from the collection bin involves allowing the dust loaded eddy currents to flow along the outer walls of the collection bin while being separated from the baffle gap area by the skirt wall. The baffle plate 7 has a top surface located a small distance above the lowest edge of the outer wall 13A of the separator section 2, for instance, 1 inch. The bottom separator wall creates a skirt that extends below the plate that supports the wall that in turn sits on top of the collection bin 24. This creates a concentric annular space 12 between the collection bin wall and the skirt 13A of the separator wall 13. This concentric, toroid space, reduces the re-uptake of dust already in collection bin 24.

B. The second mechanism for reducing re-uptake is formed by a downward lip 8 on the edge at the underside of the baffle plate 7. This lip 8 re-directs the eddy current flow in the center of the bin, to downward and away from the gap 10 in the baffle plate.

In the center of the separator section is a vortex tube 15 or outlet tube which is typically of the same diameter as, or slightly larger diameter than the inlet tube. The vortex tube 15 extends vertically from the top of the separator to about midway or slightly below the inlet tube. The space between the baffle and the bottom of the vortex tube can be left open, but preferably this space enclosed with a generally cylindrical cage structure 16 covered with a fine mesh 17, typically a 42×42 woven stainless steel screen. This mesh 17 reduces air turbulence and resistance and thus increases airflow while also preventing the excess of dust that may flow into the filter air in event of the overfilling of the collection bin.

The vortex tube assembly may or may not also support the baffle assembly. If the Vortex tube is supporting the baffle, a fastener 18 (see enlargement in FIG. 2A), can be removed and the baffle removed by rotating it so that a slot located on its outer edge, disengages a headed fastener. In use, the air flow causes the baffle to bear against this slot.

The baffle plate 7 may have a cup section 19 concentric and roughly equal in diameter to the vortex tube. This cup section serves as a storage area for dust that has been back charged from the filter during pulse cleaning, as described later.

In addition, this cup section 19 may also have a drop valve arrangement that automatically empties stored back-charged dust. This drop valve here consists of an inverted conical cup 21 that rides on a central shaft 22. During regular operation, this cup 21 is held closed against the collection cup 19 by the pressure differential between the collection bin 24 and the separator section 2. When the blower(s) are turned off or during pulse cleaning, the cup drops down and opens the cup section 19. The back-charged dust drops directly into the bin 24 below. The drop valve cup 21 is made of metal or molded plastic and has a conical surface 23 that mates with the cup section 19 and is steeply angled so as to be self-cleaning.

In some applications, such as collecting concrete grinding dust which is very fine and bridges easily, a baffle without a drop valve in the cone may be better suited. To help prevent bridging, a weighted chain can extend through the opening in the baffle cone to break up any bridging of the dust.

The base of the separator section is supported with a steel base ring 47 welded in place. This ring 47 has a standard arrangement of holes that are available to allow the attachment of optional accessories, such as a wall bracket, a heavy-duty cart, a hopper assembly, etc.

The separator section base ring 47 is held to the collection bin 24 with a steel clamp ring 49 and with a gasket 50 to seal against air leaks.

The wall bracket and cart may incorporate a bin lift mechanism that will raise the empty bin off the floor and lower the bin when full to the floor. This mechanism may be foot or hand operated. The cart may also lift the bin by picking it off the floor by first griping the drum at floor level and lifting the drum by tilting the cart backwards.

The collection bin 24 may comprise a pail or drum of standard or custom construction in fiber, metal or plastic. The bin may have wheels, casters, glides or a dolly to allow easy rolling. In the standard arrangement of the dust collector, the collection bin 24 serves as a base for the rest of the unit. Options for supporting the drum and the rest of the unit include a wall mount bracket, a heavy duty wheeled cart or a hopper and valve assembly. The wall mount bracket and heavy duty cart may include a lift mechanism that allows the collection bin to be lifted into place and lowered to the floor when full.

For the safe and convenient disposal of dust, the collection bin 24 may include a disposable liner bag 53. To prevent the air behind the bag to expand and cause the bag to be sucked upwards into the separator, a vinyl tube 52 is connected via a barbed fitting through the bin wall 51 of the collection bin, and through the wall 54 of the filter section 26. The air pressure in the filter section is lower than the air pressure in the bin, so this pressure differential pulls the liner bag back against the bin wall.

To detect dust levels in the bin and help avoid overfilling the bin 24, a clear window [55] may be included. Typically, this consists of a clear, die cut polycarbonate plastic window, sealed and bolted over a hole in the side wall in towards the top of the bin. When the dust fills the bag to the window, it is easy to see the difference in appearance. An alternate or additional level detection method may use a proximity sensor such as an infrared or ultrasonic sensor and alarm device, e.g., dust level sensor arrangement (U.S. Pat. No. 8,514,090).

An additional option available is a collection hopper with a dump valve that stores the dust during operation under negative pressure and, when the unit is turned off, manually dumps the dust into a bag positioned below the hopper. The bag can be a conventional individual bag or a tubular bag with dispenser such as a Longo bag device.

### Filter Section:

The filter section 26 favorably can be formed of a cylindrical chamber approximately the same diameter as the separator Here, one or more final filters 27 can be arranged so the air flows from inside out or outside in and there can be one, two, or multiple filters. Typically, pleated HEPA media is used, formed into a cylinder or a conic frustum, open at one end 28 and closed at the other. The open end allows the filtered air to flow to the respective associated blower motor 30.

The filter section 26 is attached atop the separator section 2 with a band clamp 46 that engages a rolled edge so that the line between the two sections is sealed against air leakage.

In the case of multiple cartridge filters, there may be partitions 29 separating the filters which assist in the pulse cleaning. These partitions prevent the back-pulsed dust from re-entraining on a neighboring filter.

The filter section 26 is separated from the separator section 2 by either a conical divider such as the top plate 6, or alternatively a flat plate with a collar. This collar may be part of the vortex tube 15 and or part of a tray that is the shape of an open-topped toroid.

### Motor Blower Section

The low profile, high pressure design uses one, two, or three high speed blowers 30 each producing 50 to 90 inches of water pressure at 130 to 150 CFM of air flow. These blowers are supported on a steel plate 40 with their inlets facing downward to communicate with the filter section.

The blowers and associated motors are supported as necessary and arrangements are provided for exhausting the work air as well as supplying cooling air, and the exhausting of the cooling air. One arrangement uses a hold down plate 42 to position the blower and its riser tube 41 to create clearance for the pulse valve, described shortly. A second hold down plate 43 isolates the incoming motor cooling air from the hot exhaust cooling air and working air.

A cowling or outer blower cover 31 is provided that protects the motor assembly, channels the cooling and working air as required and absorbs sound.

A Magnetic motor starter can provide overload protection as well as remote starting via a hand-held pendant. Alternatively, a single-pole or double-pole switch can be used.

### Pulse Cleaning,

During use, the filter(s) gradually become blocked and need cleaning. A pulse valve mechanism allows cleaning without removing the filters. To clean the filter or filters, the blower(s) 30 are left running, the inlet is closed off using the blast gate 33 on the system inlet tube 1. This causes a buildup of negative pressure. The pulse valve or valves are then opened via hand operated levers 31 allowing a pulse of air to enter the filters from the clean side to the dust side. This reverse air flow pushes dust off the filter media while flexing the media, which assists in removing the dust. Multiple pulses are required and will typically maintain the filter(s) at 80% of the performance of a new filters.

Alternately, a mechanized pulsing can be used. Solenoid or motor operated mechanism can open and close the pulse valve. A pilot valve mechanism can use the higher differential pressure that occurs when a filter is overloaded to activate a pulsing valve to utilize the systems negative pressure to create a reverse pulse.

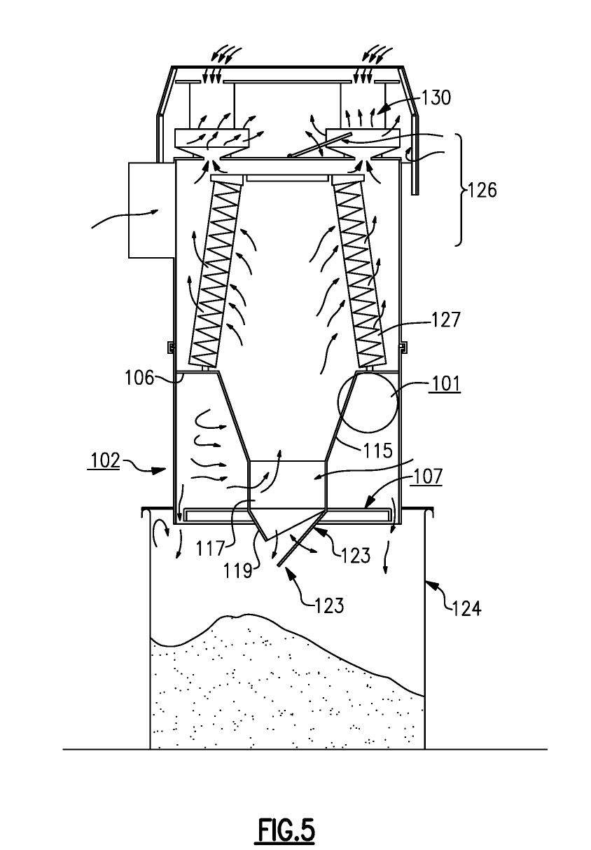

When a single filter is used, a valve consisting of a lever and a single or multiple plates that cover openings in the motor plate may be used. For multiple filters a concentric valve plate arrangement is used. This is a flat plate 32 with a gasket seal and lift lever 31 that is concentric to the inlet tube 41 for the respective blower(s) 30. A plan arrangement of this is illustrated in FIG. 4, where the plate 40 is provided with openings 45 around the blower inlet riser tube 41. For purposes of explanation, one of these is shown with the blower and motor 30 in place, and one is shown without the blower to show the position of the flat plate 32 and lift lever 31. Positions of the partitions 29 are indicated with dash line in FIG. 4.

The dust removed from the filters falls downward. In the illustrated arrangement the conical top late 6 acts to funnel the dust downward into the baffle cup 19 to be stored. During pulsing or when the unit is turned off, the drop valve 21 opens due to pressure equalization, allowing the downward flow of dust into the collection bin 24. As explained above, for some applications it is preferred to eliminate the drop valve and leave the bottom of the cone open to the bin.

An alternate arrangement may employ a toroid section tray below the filter(s) to catch the back-pulsed dust, which may then be emptied manually. An additional advantage of this arrangement is that it acts as secondary separation when the expanding dust laden air expands as it exits the vortex tube and allows some of the dust to drop out before it reaches the filter(s) 27.

FIG. 5 illustrates a variation of the LPHP dust separator and collector that employs the same principles. Here, components that correspond to similar parts in the earlier-discussed embodiments are identified by similar reference numbers, but raised by 100. In this embodiment dust-laden air enters the inlet tube 101 into the cylindrical separation chamber 102 formed between the top plate 106 and baffle plate 107. The baffle plate may have geometry the same or similar to that of the first embodiment. The air proceeds around the separation chamber 102 and then out through the screen 117 and a conic vortex tube 115 into the filter chamber 126 where the air passes through filter 127 and is exhausted out by motor driven blowers 130. The separated dust mainly drops through the peripheral gap of the baffle plate 107 into a collection bin 124. In this embodiment, any dust separated out in the space inside the filter falls down into the funnel like vortex tube 115 and into a catchment 119, which has a dust door 123 hinged at one side. During operation, the higher pressure in the dust collection bin 124 than within the space in the vortex tube 115 keeps the door 123 pushed closed, but when the machine is turned off and when it is pulsed, the door 123 can fall open to allow the trapped dust in the catchment 119 to fall into the bin 124.

Many variations of this LPHP system can be constructed according to the main principles of this invention, and as mentioned before, the principles can be applied to an LPLP (low-profile, low-pressure) dust collection system, where that would be appropriate.

What is claimed is:

1. A powerful compact, high pressure, high flow vacuum or dust collector, comprising
a low profile generally cylindrical separator section having a inlet tube through which a stream of air and entrained dust particles enters the separator section, the inlet tube extending tangentially into a top portion; a top plate at a top end of the separator section with a vortex tube extending downward from the top plate; the stream of air having a predetermined direction of spiral air flow at an outer cylindrical wall of the separator section, and a separator baffle disposed at a lower end of said separator section below a lower end of the vortex tube, said separator baffle having periphery that defines a peripheral gap from the cylindrical wall of said separator section, the gap increasing in width in the direction of air flow;
a dust collection section positioned at the lower end of the separator section; and
a blower and filter section positioned above the separator section to receive the stream of air passing through said vortex tube.

2. A powerful compact, high pressure, high flow dust collector as in claim 1 wherein said separator baffle has a contoured upper surface that slopes to encourage outward flow of particles and is easily removed for clearing of trash from the separator section.

3. A powerful compact, high pressure, high flow dust collector as in claim 1 wherein said baffle plate has a downwardly extending skirt formed along said peripheral gap configured to
discourage re-uptake of material from the collection bin.

4. A powerful compact, high pressure, high flow dust collector as in claim 1 wherein said dust collection section has a cylindrical wall that has a greater diameter than said baffle plate, and forming toroid shaped section at a lower end of said separator section that is configured so as to segregate dust loaded eddy flow in the collection bin from re-entering the separation section through the gap of the baffle plate.

5. A powerful compact, high pressure, high flow dust collector as in claim 1 comprising interchangeable baffle plates to accommodate different conditions or materials.

6. A powerful compact, high pressure, high flow dust collector as in claim 1 wherein said peripheral gap extends about 200 to 270 degrees around the periphery of said baffle plate.

7. A powerful compact, high pressure, high flow dust collector as in claim 1 wherein said peripheral gap increases in gap width in the direction of air flow from about ¼ inch to about 2 inches.

8. A powerful compact, high pressure, high flow dust collector as in claim 1 wherein said separator section further includes a generally cylindrical mesh screen extending down below a lower end of said vortex tube.

9. A powerful compact, high pressure, high flow dust collector as in claim 1 wherein said baffle plate has a dust cup positioned at a center thereof below the lower end of said vortex tube for containing dust falling from said blower and filter section.

10. A powerful compact, high pressure, high flow dust collector as in claim 9 wherein said dust cup includes a drop valve arrangement positioned in a lower open end thereof that automatically empties stored back-charged dust into the collection section.

11. A powerful compact, high pressure, high flow dust collector as in claim 10 wherein said drop valve arrangement comprises an inverted conical cup that rides on a vertical central shaft.

12. A powerful compact, high pressure, high flow dust collector as in claim 9 wherein said top plate of said separation section is conic in shape forming a funnel to guide dust from the filter and blower section into said vortex tube and thence into said dust cup.

13. A powerful compact, high pressure, high flow dust collector as in claim 1 that features at least one pulse plate and an associated at least one pulse lever configured for reverse pulse cleaning of filters of said blower and filter section.

14. A powerful compact, high pressure, high flow dust collector as in claim 1 further comprising storage means for storing back washed dust from the pulse cleaning action and automatically dumping such back washed dust into the collection section.
